(19) United States
(12) Patent Application Publication
(10) Pub. No.: US 2026/0121143 A1
(43) Pub. Date: Apr. 30, 2026

(54) SECONDARY BATTERY

(71) Applicant: SK ON CO., LTD., Seoul (KR)

(72) Inventor: Seung Min LEE, Daejeon (KR)

(21) Appl. No.: 19/353,748

(22) Filed: Oct. 9, 2025

(30) Foreign Application Priority Data
Oct. 24, 2024 (KR) 10-2024-0146749

(51) Int. Cl. H01M 10/52; H01M 50/105; H01M 50/474; H01M 50/477; H01M 50/483; H01M 50/491

(52) U.S. Cl. CPC H01M 10/523; H01M 50/105; H01M 50/474; H01M 50/477; H01M 50/483; H01M 50/491

(57) ABSTRACT

A secondary battery according to exemplary embodiments of the present disclosure includes an electrode assembly, electrode leads joined to electrode tabs extending from each of a cathode and an anode of the electrode assembly, a pouch that accommodates and seals the electrode assembly, and exposes the electrode leads to the outside, and a catalyst part for gas removal disposed inside the pouch, between the electrode assembly and a pouch sealing portion, on a side where the electrode tabs of the electrode assembly extend.

### CROSS-REFERENCE TO RELATED APPLICATIONS

This patent application claims the priority and benefits of Korean Patent Application No. 10-2024-0146749 filed on Oct. 24, 2024, the disclosure of which is incorporated herein by reference in its entirety.

### BACKGROUND

### 1. Field of the Invention

The present disclosure relates to a secondary battery.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, lithium secondary batteries are actively developed and applied due to their high operating voltage, high energy density per unit weight, and advantages in charging speed and weight reduction.

The lithium secondary battery may include an electrode assembly including a cathode, an anode, and a separation membrane, and an electrolyte for impregnating the electrode assembly. The electrode assembly and electrolyte may be accommodated in an outer case, for example, such as a pouch type.

The electrolyte may continuously decompose during battery operation or under high-temperature conditions, generating flammable gases. Therefore, to prevent explosions or fires in the secondary battery, it is necessary to design a secondary battery capable of removing flammable gases.

### SUMMARY

An object of the present disclosure is to provide a secondary battery that may exhibit improved safety.

A secondary battery according to exemplary embodiments of the present disclosure includes: an electrode assembly; electrode leads joined to electrode tabs extending from each of a cathode and an anode of the electrode assembly; a pouch that accommodates and seals the electrode assembly, and exposes the electrode leads to the outside; and a catalyst part for gas removal disposed inside the pouch, between the electrode assembly and a pouch sealing portion, on a side where the electrode tabs of the electrode assembly extend.

In exemplary embodiments, the catalyst part may include a substrate and a catalyst layer coated on the substrate.

In exemplary embodiments, the substrate may have a porous structure.

In exemplary embodiments, the substrate may have a mesh structure.

In exemplary embodiments, the substrate may include through holes extending parallel to the direction in which the electrode tabs extend in the electrode assembly.

In exemplary embodiments, the substrate may be a ceramic substrate or a metal substrate.

In exemplary embodiments, a catalyst of the catalyst layer may include at least one of a metal oxide catalyst and a noble metal catalyst.

In exemplary embodiments, the metal oxide catalyst may include at least one selected from the group consisting of titanium dioxide (TiO₂), cerium dioxide (CeO₂), manganese dioxide (MnO₂), copper oxide (CuO), and nickel oxide (NiO).

In exemplary embodiments, the metal oxide catalyst may be included in an amount of 5% by weight to 20% by weight based on the weight of the substrate.

In exemplary embodiments, the noble metal catalyst may include at least one selected from the group consisting of platinum (Pt), palladium (Pd), and rhodium (Rh).

In exemplary embodiments, the noble metal catalyst may be included in an amount of 0.1% by weight to 5% by weight based on the weight of the substrate.

In exemplary embodiments, the catalyst part may cover one surface of the electrode assembly from which the electrode tab extends.

In exemplary embodiments, the catalyst part may cover all surfaces of the electrode assembly.

In exemplary embodiments, the pouch may include a first pouch and a second pouch formed outside the first pouch, and the catalyst part may be disposed between the first pouch and the second pouch on the side where the electrode tab of the electrode assembly extends.

In exemplary embodiments, the secondary battery may further include a second catalyst part disposed inside the first pouch between the electrode assembly and a sealing portion of the first pouch on the side where the electrode tab of the electrode assembly extends.

The secondary battery according to exemplary embodiments of the present disclosure may reduce the concentration of flammable gases, thereby improving the thermal safety of the secondary battery.

The secondary battery according to the present disclosure may be widely applied in green technology fields, such as electric vehicles, battery charging stations, as well as solar power generation, wind power generation, and the like, which use the batteries. In addition, the lithium secondary battery according to the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are a plan view and a cross-sectional view, respectively, of a secondary battery according to exemplary embodiments;

FIG. 3 is a cross-sectional view of a secondary battery including a catalyst part according to exemplary embodiments;

FIG. 4 is an enlarged cross-sectional view illustrating a protruding portion of an electrode lead of the secondary battery according to exemplary embodiments;

FIG. 5 is a schematic view illustrating the catalyst part according to exemplary embodiments;

FIG. 6 is a schematic view illustrating a substrate according to exemplary embodiments;

FIGS. 7 to 9 are schematic views illustrating a secondary battery including a catalyst device according to exemplary embodiments.

### DETAILED DESCRIPTION OF THE INVENTION

According to exemplary embodiments of the present disclosure, a secondary battery including a catalyst part is provided.

The exemplary embodiments will now be described in more detail with reference to the accompanying drawings. However, the drawings and embodiments included in the present specification are merely intended to aid in the understanding of the technical concept of the present disclosure. Accordingly, the present disclosure should not be construed as being limited to the matters described in the drawings and embodiments.

The terms “upper portion,” “lower portion,” “upper surface,” “lower surface,” and “side surface” as used herein do not designate absolute positions, but are used in a relative sense. For example, such terms are used to distinguish regions with respect to a particular reference surface.

The terms “inner side” and “outer side” as used herein do not designate absolute directions, but are used in a relative sense. For example, the terms are used relatively to designate different directions for a specific structure.

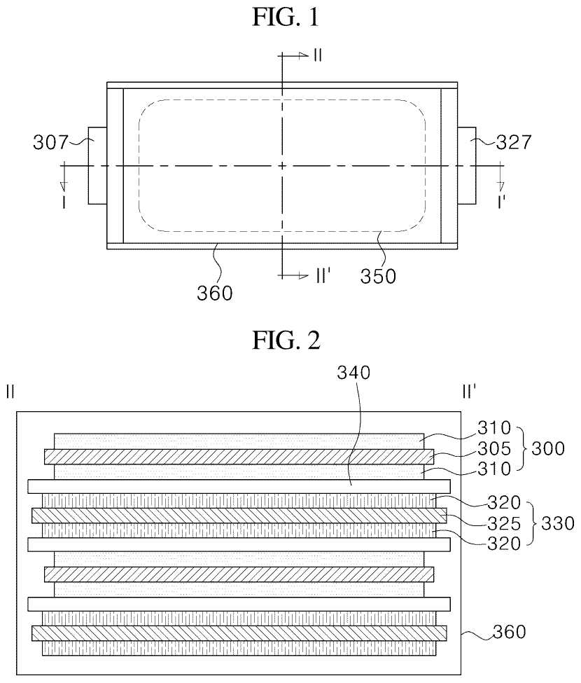

FIGS. 1 and 2 are a plan view and a cross-sectional view, respectively, illustrating a secondary battery according to exemplary embodiments. For example, FIG. 2 is a cross-sectional view taken along line II-II′ of FIG. 1 in the thickness direction.

The secondary batteries shown in FIGS. 1 and 2 are schematically illustrated for convenience of description, and the structure of the secondary batteries of the present disclosure is not limited to that shown in FIGS. 1 and 2.

Referring to FIGS. 1 and 2, the secondary battery according to some embodiments includes an electrode assembly 350, electrode leads 307 and 327, and a pouch 360.

According to exemplary embodiments, a unit cell is defined by a cathode 300, an anode 330 and a separation membrane 340, and a plurality of unit cells may be stacked to form, for example, the electrode assembly 350.

The cathode 300 may include a cathode current collector 305 and a cathode active material layer 310 formed by applying a cathode active material on the cathode current collector 305. The cathode active material may include a compound capable of reversibly intercalating and deintercalating lithium ions. In this case, the secondary battery may be provided as a lithium secondary battery.

In exemplary embodiments, the cathode active material may include lithium-transition metal composite oxide particles. For example, the lithium-transition metal composite oxide particles may include nickel (Ni), and may further include at least one of cobalt (Co) and manganese (Mn).

For example, the cathode current collector 305 may include stainless steel, nickel, aluminum, titanium, copper, zinc, or an alloy thereof, and preferably includes aluminum or an aluminum alloy.

For example, the cathode active material may be mixed and stirred with a binder, a conductive material, and/or a dispersing agent in a solvent to prepare a slurry. The slurry may be coated on the cathode current collector 305, then compressed and dried to prepare the cathode 300 including the cathode active material layer 310.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as the cathode binder. In this case, the amount of the binder for forming the cathode active material layer may be reduced and the amount of the cathode active material may be relatively increased, thereby improving the output and capacity of the secondary battery.

The conductive material may be included to promote electron migration between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, and LaSrMnO₃, etc.

The anode 330 may include the anode current collector 325 and the anode active material layer 320 formed by coating the anode active material onto the anode current collector 325.

As the anode active material, any active material known in the art may be used, so long as it is capable of absorbing and desorbing lithium ions. For example, carbon-based materials such as crystalline carbon, amorphous carbon, carbon composite, carbon fibers, etc., a lithium alloy, or a silicon (Si)-based active material may be used. Examples of the amorphous carbon may include hard carbon, coke, mesocarbon microbeads (MCMB), mesophase pitch-based carbon fibers (MPCF), or the like.

Examples of the crystalline carbon may include graphite-based carbon such as natural graphite, artificial graphite, graphitized coke, graphitized MCMB, graphitized MPCF or the like. Elements included in the lithium alloy may include aluminum, zinc, bismuth, cadmium, antimony, silicon, lead, tin, gallium or indium or the like.

The anode current collector 325 may include stainless steel, copper, nickel, aluminum, titanium, or an alloy thereof. Preferably, the anode current collector 325 includes copper or a copper alloy.

For example, a slurry may be prepared by mixing the anode active material with the above-described binder, conductive material, thickener, and the like in a solvent, followed by stirring the same. The slurry may be coated on at least one surface of the anode current collector 325, followed by compression and drying to prepare the anode 330 including the anode active material layer 320.

As the binder and the conductive material, materials which are substantially the same as or similar to the above-described materials used in the cathode active material layer 310 may be used. In some embodiments, a binder for forming an anode may include, for example, an aqueous binder such as styrene-butadiene rubber (SBR) to ensure compatibility with a carbon-based active material, and may be used together with a thickener such as carboxymethyl cellulose (CMC).

A separation membrane 340 may be interposed between the cathode 300 and the anode 330. The separation membrane 340 may include a porous polymer film made of a polyolefin polymer such as ethylene homopolymer, propylene homopolymer, ethylene/butene copolymer, ethylene/hexene copolymer, ethylene/methacrylate copolymer. The separation membrane 340 may include a nonwoven fabric made of glass fibers having a high melting point, polyethylene terephthalate fibers, etc.

According to exemplary embodiments, the cathode 300 and the anode 330 may be alternately and repeatedly stacked with the separation membrane 340 interposed therebetween, thereby defining the electrode assembly 350.

The electrode assembly 350 may be a winding-type, a stacking-type, a z-folding-type, or a stacked-folding type.

The electrode assembly 350 may be accommodated in the pouch 360 together with an electrolyte to define a secondary battery. According to exemplary embodiments, a non-aqueous electrolyte may be used as the electrolyte.

The non-aqueous electrolyte may include a lithium salt of an electrolyte and an organic solvent. The lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfuroxide, acetonitrile, dimethoxyethane, diethoxyethane, vinylene carbonate, sulfolane, gamma-butyrolactone, propylene sulfite and tetrahydrofuran, etc. may be used. These may be used alone or in combination of two or more thereof.

As shown in FIGS. 1 and 2, electrode leads (a cathode lead 307 and an anode lead 327) joined to electrode tabs (cathode tabs 306 and anode tabs 326) extending from the cathode current collector 305 and the anode current collector 325, respectively, which belong to each electrode cell, may protrude and extend to one side of the pouch 360. The electrode leads 307 and 327 may be fused together with the one side of the pouch 360 to extend or be exposed to the outside of the pouch 360.

Although FIG. 1 illustrates that the cathode lead 307 and the anode lead 327 protrude from different sides of the pouch 360 in the planar direction, the positions of the electrode leads are not limited thereto. For example, the electrode leads may also protrude from the same side of the pouch 360.

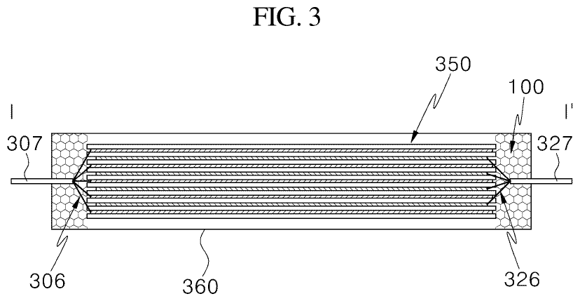

A secondary battery according to exemplary embodiments of the present disclosure includes an electrode assembly 350, electrode leads 307 and 327, a pouch 360, and a catalyst part 100. FIG. 3 is a cross-sectional view illustrating a secondary battery including the catalyst part 100 disposed on both sides according to exemplary embodiments. For example, FIG. 3 is a cross-sectional view taken along line I-I′ of FIG. 1 in the thickness direction.

The pouch 360 accommodates and seals the electrode assembly 350, and exposes the electrode leads 307 and 327.

The catalyst part 100 is disposed between the electrode assembly 350 and the pouch sealing portion, within the pouch 360, on the side where the electrode tabs 306 and 326 of the electrode assembly 350 extend. Accordingly, flammable gases generated within the secondary battery may pass through the catalyst part 100 and be oxidized into an inert gas, as described below. This inert gas is nonflammable even if released to the outside in the event of a pouch rupture, thereby preventing further occurrence or propagation of a fire.

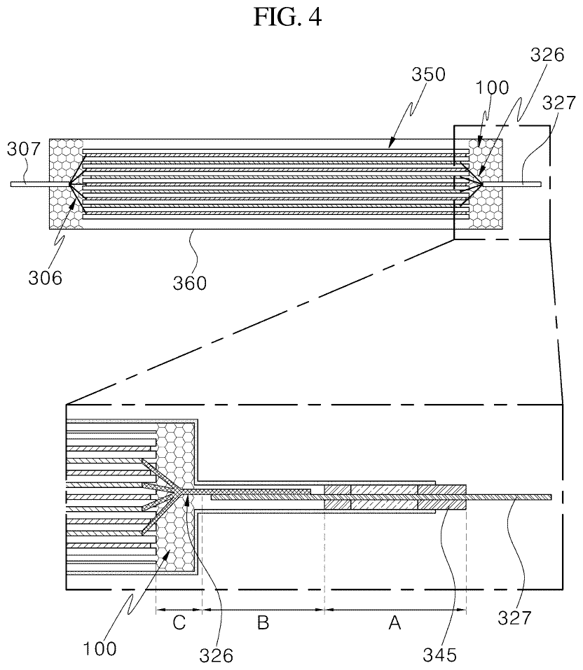

FIG. 4 is an enlarged cross-sectional view illustrating a protruding portion of an electrode lead of the secondary battery according to exemplary embodiments. For example, FIG. 4 is an enlarged cross-sectional view of the region surrounding the anode lead 327, but the same structure may also be applied to the region surrounding the cathode lead 307.

Referring to FIG. 4, region A may be the sealing portion, and region B may be a welding portion. In FIG. 4, only region A is depicted as the sealing portion, but region B may also be included in the sealing portion.

In exemplary embodiments, the sealing portion may be sealed with an insulating material 345, such as insulating tape.

In exemplary embodiments, the catalyst part may be disposed in region C.

The flammable gas produced within the secondary battery may result from the decomposition of the above-described electrolyte, such as a carbonate-based electrolyte. Examples of such flammable gases include methane (CH₄), carbon monoxide (CO), ethane (C₂H₆), ethylene (C₂H₄), propane (C₃H₈), propylene (C₃H₆), and hydrogen (H₂).

The decomposition rate of the electrolyte may accelerate at temperatures of 200° C. or higher, at which thermal runaway of the secondary battery occurs. If the concentration of the flammable gas produced by the decomposition of the electrolyte exceeds the lower explosive limit (LEL), the secondary battery may explode.

When the secondary battery includes the catalyst part 100, the flammable gas may pass through the catalyst part and be oxidized into inert gases such as carbon dioxide (CO₂) and water vapor (H₂O) within the temperature range where thermal runaway intensifies. Accordingly, the explosion risk of the secondary battery may be reduced.

The oxidation reaction rate of flammable gases by the catalyst part 100 may be represented by Equation 1 below.

$$r = {k [ A ] [ {O}_{2} ]}^{α} \qquad [ Equation 1 ]$$

In Equation 1, r (unit: mol/cm³·s) represents the oxidation reaction rate of the flammable gas, k represents the reaction rate constant (unit: cm³/mol·s), A represents the flammable gas, and a represents the reaction coefficient of oxygen molecules per flammable gas molecule.

In Equation 1, [A] and [O₂] represent the concentration of flammable gas A and the concentration of oxygen (O₂) (unit: mol/cm³), respectively.

Referring to Equation 1, the oxidation reaction rate of the flammable gas varies depending on the reaction rate constant k. According to the Arrhenius equation, the reaction rate constant k increases as the activation energy (Ea) decreases and the temperature increases.

The range of the reaction rate constant k is not limited thereto, but may be, for example, from 10⁻³ cm³/mol·s to 10⁻¹ cm³/mol·s. Within this range, the flammable gas may be oxidized into an inert gas before its concentration exceeds the lower explosive limit.

The range of the reaction coefficient α may vary depending on the type of the catalyst or the flammable gas. The range of the reaction coefficient α is not limited thereto, but may be, for example, from 0.5 to 5.0.

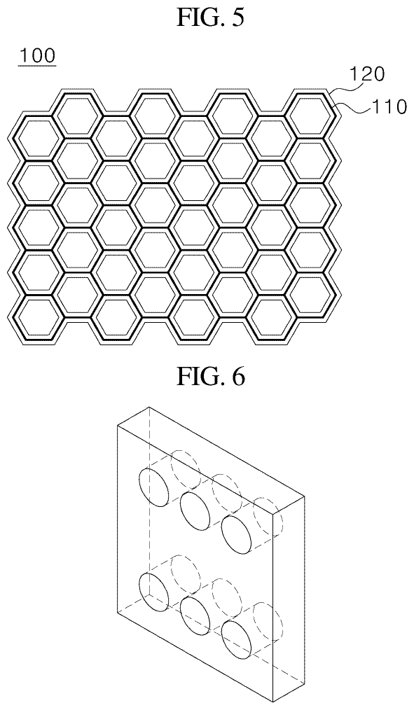

FIG. 5 is a schematic view illustrating the catalyst part according to exemplary embodiments.

Referring to FIG. 5, the catalyst part 100 may include a substrate 110 and a catalyst layer 120 coated on the substrate 110.

In FIG. 5, the catalyst part 100 is shown as having a hexagonal honeycomb structure, but is not limited thereto. When the catalyst part 100 has a porous structure, gas may smoothly flow through the catalyst part, thereby facilitating the oxidation of flammable gas into nonflammable gas and the emission of the nonflammable gas.

The substrate 110 is not particularly limited as long as it can support a catalyst material, and may be, for example, a ceramic substrate, a metal substrate, or the like.

In exemplary embodiments, the ceramic may be, for example, alumina (Al₂O₃, aluminum oxide), zirconia (ZrO₂, zirconium oxide), silicon carbide (SIC), or the like.

In exemplary embodiments, the metal substrate may be stainless steel (e.g., 316L, 304, etc.), a nickel-based alloy (Inconel), or the like.

In exemplary embodiments, the substrate 110 may have a porous structure.

In exemplary embodiments, the substrate 110 may have a mesh structure.

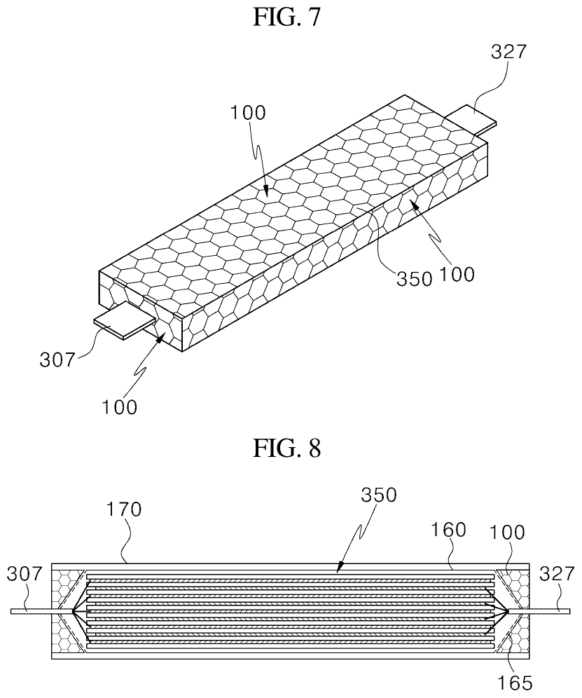

FIG. 6 is a schematic view illustrating the substrate according to exemplary embodiments.

Referring to FIG. 6, in exemplary embodiments, the substrate 110 may include through holes parallel to the extending direction of the leads in the electrode assembly.

The catalyst layer 120 may be a layer coated with a catalyst on at least one surface of the substrate 110.

The catalyst according to exemplary embodiments may be coated on all surfaces of the substrate 110 and may include a metal oxide catalyst, a noble metal catalyst, or the like.

The metal oxide catalyst may be, for example, titanium dioxide (TiO₂), cerium dioxide (CeO₂), manganese dioxide (MnO₂), copper oxide (CuO), nickel oxide (NiO), or the like.

When the catalyst part 100 includes titanium dioxide, the thermal stability and oxidation activity of the catalyst part 100 may be improved.

When the catalyst part 100 includes cerium dioxide, the oxygen storage and release capacity of the catalyst part 100 may be improved.

When the catalyst part 100 includes manganese dioxide, the oxidation reaction of a flammable gas may be promoted.

When the catalyst part 100 includes copper oxide, selective oxidation of a flammable gas may be possible. For example, copper oxide may oxidize carbon monoxide (CO), a flammable gas, to carbon dioxide (CO₂), a nonflammable gas.

When the catalyst part 100 includes nickel oxide, the oxidation and hydrogenation reactions of flammable gases may be accelerated.

The noble metal catalyst may be, for example, platinum (Pt), palladium (Pd), or rhodium (Rh).

When the catalyst part 100 includes platinum, the catalyst part 100 may have high oxidation activity.

When the catalyst part 100 includes palladium, the oxidation and hydrogenation reactions of flammable gases may be promoted.

When the catalyst part 100 includes rhodium, the catalyst part 100 may have high oxidation activity.

According to exemplary embodiments, the amount of the metal oxide catalyst included in the catalyst part 100 may be 5% by weight (“wt %”) to 20 wt % based on the weight of the substrate.

According to exemplary embodiments, the amount of the noble metal catalyst included in the catalyst part may be 0.1 wt % to 5 wt % based on the weight of the substrate. When the metal oxide and/or noble metal are included in the above weight range, the oxidation reaction of the flammable gas may sufficiently occur while not impeding the flow of the flammable and nonflammable gases passing through the catalyst part.

In exemplary embodiments, the catalyst part 100 may be formed of only the catalyst material without including the substrate 110. The catalyst part 100 may be formed of the above-described materials of the catalyst layer 120. For example, the catalyst part 100 may include at least one selected from the group consisting of a nickel-based alloy, zirconia, alumina, and titanium oxide. Accordingly, the catalyst part 100 may be manufactured without forming an additional coating layer.

In exemplary embodiments, the catalyst part 100 may cover one surface of the electrode assembly 350 from which the electrode tab extends.

In exemplary embodiments, the catalyst part 100 may have a specific surface area of 50 cm²/g to 50,000 cm²/g, 800 cm²/g to 30,000 cm²/g, or 500 cm²/g to 10,000 cm²/g. Within these ranges, the oxidation rate at which the flammable gas is oxidized into an inert gas may be appropriate.

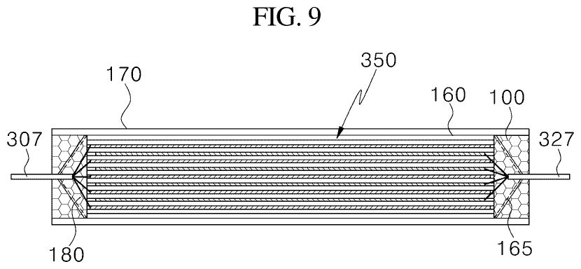

FIGS. 7 to 9 are schematic views illustrating a secondary battery including a catalyst device according to exemplary embodiments.

Referring to FIG. 7, in exemplary embodiments, a catalyst part 100 may cover all surfaces of an electrode assembly 350. Accordingly, the oxidation rate of a flammable gas into a nonflammable gas by the catalyst part 100 may be further improved.

Referring to FIG. 8, in exemplary embodiments, a pouch 360 may include a first pouch 160 and a second pouch 170 formed on the outside of the first pouch 160. The catalyst part 100 may be disposed between the first pouch 160 and the second pouch 170 on the side where the electrode tabs of the electrode assembly extend. In this case, a vent portion 165 may further be included in a portion of the first pouch 160 adjacent to the catalyst part 100.

The vent portion 165 is vented when the pressure inside the first pouch 160 reaches a predetermined pressure, thereby allowing the flammable gas inside the first pouch 160 to flow into the catalyst part 100. Accordingly, the oxidation rate of the flammable gas into an inert gas may be further improved.

Referring to FIG. 9, in exemplary embodiments, the secondary battery may further include a second catalyst part 180 disposed inside the first pouch 160, between the electrode assembly 350 and the sealing portion of the first pouch 160, on the same side where the electrode tabs of the electrode assembly extend. In exemplary embodiments, the catalyst part 100 may be disposed at a position adjacent to the second pouch 170, and the second catalyst part 180 may be disposed inward in the longitudinal direction, closer to the sealing portion of the first pouch 160.

1. A secondary battery comprising:
an electrode assembly;
electrode leads joined to electrode tabs extending from each of a cathode and an anode of the electrode assembly;
a pouch that accommodates and seals the electrode assembly, and exposes the electrode leads to the outside; and
a catalyst part for gas removal disposed inside the pouch, between the electrode assembly and a pouch sealing portion, on a side where the electrode tabs of the electrode assembly extend.

2. The secondary battery according to claim 1, wherein the catalyst part comprises a substrate and a catalyst layer coated on the substrate.

3. The secondary battery according to claim 2, wherein the substrate has a porous structure.

4. The secondary battery according to claim 2, wherein the substrate has a mesh structure.

5. The secondary battery according to claim 2, wherein the substrate comprises through holes extending parallel to the direction in which the electrode tabs extend in the electrode assembly.

6. The secondary battery according to claim 2, wherein the substrate is a ceramic substrate or a metal substrate.

7. The secondary battery according to claim 2, wherein a catalyst of the catalyst layer comprises at least one of a metal oxide catalyst and a noble metal catalyst.

8. The secondary battery according to claim 7, wherein the metal oxide catalyst comprises at least one selected from the group consisting of titanium dioxide (TiO₂), cerium dioxide (CeO₂), manganese dioxide (MnO₂), copper oxide (CuO), and nickel oxide (NiO).

9. The secondary battery according to claim 7, wherein the metal oxide catalyst is included in an amount of 5% by weight to 20% by weight based on the weight of the substrate.

10. The secondary battery according to claim 7, wherein the noble metal catalyst comprises at least one selected from the group consisting of platinum (Pt), palladium (Pd), and rhodium (Rh).

11. The secondary battery according to claim 7, wherein the noble metal catalyst is included in an amount of 0.1% by weight to 5% by weight based on the weight of the substrate.

12. The secondary battery according to claim 1, wherein the catalyst part covers one surface of the electrode assembly from which the electrode tab extends.

13. The secondary battery according to claim 1, wherein the catalyst part covers all surfaces of the electrode assembly.

14. The secondary battery according to claim 1, wherein the pouch comprises a first pouch and a second pouch formed outside the first pouch, and
wherein the catalyst part is disposed between the first pouch and the second pouch on the side where the electrode tab of the electrode assembly extends.

15. The secondary battery according to claim 14, further comprising a second catalyst part disposed inside the first pouch between the electrode assembly and a sealing portion of the first pouch on the side where the electrode tab of the electrode assembly extends.
